(19) United States
(12) Patent Application Publication
(10) Pub. No.: US 2015/0178711 A1
(43) Pub. Date: Jun. 25, 2015

(54) METHOD FOR CREATING A PAYMENT SYSTEM

(71) Applicant: Oleg Alexandrovich SEREBRENNIKOV, Moscow (RU)

(72) Inventor: Oleg Alexandrovich Serebrennikov, Moscow (RU)

(21) Appl. No.: 14/415,769

(22) PCT Filed: Jul. 19, 2013
(86) PCT No.: PCT/RU2013/000620

§ 371 Date: Jan. 20, 2015

(30) Foreign Application Priority Data
Aug. 24, 2012 (RU) 2012136238

(51) Int. Cl. G06Q 20/30; G06Q 20/38; G06Q 20/10

(52) U.S. Cl. CPC G06Q 20/305; G06Q 20/10; G06Q 20/3829

(57) ABSTRACT

Provided are methods of search, retrieval and processing of digital data, identification and location of network resources, electronic commerce, and distribution of physical and virtual goods and services, in particular the distribution of Internet Domain Name System (DNS) names, as well as to creation of payment instruments, payment systems, addressing and execution of payments. Specifically, a method of creating of a payment system by leasing cloud services of an OEM payment system via the Internet, where the hardware and software of the OEM payment system (the payment system cloud) is also on the Internet, using network identifiers as financial account identifiers. Also provided is a procedure for distribution of network identifiers to identify transactional accounts. Creation of transactional systems, generation of account network identifiers, protection and distribution of the identifiers and transactional account data can organized in real-time.

The present invention pertains generally to the field of computer science, methods of search, retrieval and processing of digital data, identification and location of network resources, electronic commerce, and distribution of physical and virtual goods and services, in particular the distribution of Internet Domain Name System (DNS) names, as well as to creation of payment instruments, payment systems, addressing and execution of payments.

### BACKGROUND OF THE INVENTION

Those skilled in the art know of payments using plastic cards, for example, by VISA™ and other plastic cards, but the card identifiers are hard to remember and they are not network addresses, which precludes their direct use in the network layer protocols in public networks and the Internet. Persons skilled in the art also know of the payments systems such as PayPal, Yandex.Money and others, using email identifiers, however, these identifiers cannot be used for realtime payments, because email addresses are supposed to be used with the SMTP protocol, which does not guarantee realtime delivery of messages. Said systems do not provide cloud services for a rapid and inexpensive creation of payment systems using the hardware and software of said systems, they do not provide OEM (White Label) solutions that would allow their customers promote their respective brands as the brands of a payment system built with said cloud services. O. A. Serebrennikov, in US patent application 20050114367 A1 (Ser. No. 927460/10, publ. May 26, 2005), hereafter referred to as the Serebrennikov Application or the Serebrennikov Method and incorporated here by reference, teaches of identification and location of transactional accounts and exchange of transactional messages between the parties of a transaction. However, the Serebrennikov Method does not provide a method for creation of an OEM payment system using cloud services.

Therefore, development of a payment system using prior art is a lengthy and expensive undertaking, which, in addition, has a significant cost of ownership, which makes creations of a proprietary payment system difficult, especially for a small enterprise. Another natural constraint is the difficulty in expanding a payment system beyond its proprietary customer base, as this shifts the focus of a company's activity into the payment system field, yet serving only the proprietary customer base may have a too high mean cost of single customer service. Another constraint of prior art is that the costs on transactions through third-party payment systems may be as high as 30% of the payment value as in, for example, Apple's payment system, which is mandatory for use by developers for iOS application for in-app payments.

Contemporarily, millions of people are users of various Internet social networks and applications for various devices, telecommunication operators have millions of subscribers, millions of people use the services of free email providers, and so on. While one of the main methods for monetization of the customer base of said businesses is display of paid advertisements or collection of service fees, business are looking for new new methods for monetization of their customer base. Collecting fees for payment services can be such a method, which may require creation of a proprietary payment system.

Another example of the need of a proprietary payment system is online trade in goods (including virtual goods) and services. For example, a retailer such as Wal-Mart can be a payment system, where each item of goods is assigned a DNS identifier to receive payments from users/customers.

Yet another example of the need of a proprietary payment system is trade in virtual goods such as DNS names or virtual goods in a game environment, which enables top level domains and game developers to generate revenues using the payment system business model.

The present invention eliminates said constraints by improving functional and operational characteristics of a payment system and by improving the convenience of using the system.

### SUMMARY OF THE INVENTION

The present invention advances the state of the art by introducing the method of creation of a transactional system, which exchanges transactional messages in a communications system, wherein the caller and callee resources in the communications system are connected using the network connection addressing system of said communications system; the network connection addressing system of the communications system has a database, which stores network identifiers and network addresses, wherein each network identifier corresponds to at least one network address; the network addressing system provides a resolver service to caller resources, which comprises receiving from a caller resource the network identifier of a callee resource, searching in the addressing system's database for a network address corresponding to the network identifier of the callee resource and returning the found network address of the callee resource to the caller resource, and the caller resource uses the resolved network address of the callee resource to establish a connection with the callee resource; the transactional system has a transactional account database and is a network resource, wherein each transactional resource is assigned transactional Account Network Identifier (ANId); the transactional system is assigned one or multiple Transactional System Network Addresses (TSNA), and said TSNA's are used to establish connections between network caller resources and the transactional system, which is a network resource; wherein said ANId's correspond to at least one TSNA in the network addressing system; wherein to execute a transaction, a transactional instruction is created, which has at least one ANId, the network connection addressing system is contacted for the resolver service and is given said ANId, the resolver service is executed for said ANId, and at least one said TSNA is received, which corresponds in the network connection addressing system's database to said ANId, said TSNA is used to establish a network connection with the transactional account database, which is given said transactional instruction with at least one said ANId, wherein the transactional system is subdivided into at least two Segments, each Segment is given an individual Segment in the transactional account database (DB Segment), the plurality of TSNA's is subdivided into disjoint address subsets (Address Segments) corresponding to Segments, said Address Segments are used to address connections exclusively with the corresponding DB Segment; in a selected DB Segment at least one transactional account is created, for which at least one Segment Account Network Identifier (SANId) is created, and said SAN Id corresponds in the network connection addressing system's database to at least one address in the corresponding Address Segment; said SANId is used to create said transactional instruction, to establish a connection with said DB Segment and to send said instruction to said DB Segment.

Preferably, the SANId is retrieved from said transactional instruction, and is a known transactional rule is applied to the account whose identifier is identical with the SANId retrieved from said transactional instruction.

Preferably, said transactional system is a payment system, transactional accounts are financial accounts, the transactional instruction is a payment instruction which contains at least the payer's SANId and the payment amount, and the SANId in the payment instruction identifies the payer's financial account in the corresponding DB Segment.

Preferably, said network identifiers are DNS names or Uniform Resource Identifiers (URI's), and said network addresses are IP addresses.

Preferably, an N-level DNS name registrar is furnished with a payment system Segment, and said N-level DNS names registered by said registrar are used as said SANId's to identify financial accounts in said DB Segment, each SANId is put in correspondence with at least one network address in the corresponding Address Segment, and the SANId and the corresponding at least one said address in the Address Segment is stored in the network connection addressing system.

Preferably, said payment system is created in a selected Internet top-level domain, DNS identifiers registered in said selected Internet top-level domain are used as said SANId's, said registrar is another top level domain, and said payment system Segment is used as a payment system of a distributor.

Preferably, said selected Internet top-level domain is the .PAY domain.

Preferably, said registrar is furnished with private and public keys of an asymmetric cryptography scheme, and said users, when registering said SANId's, are queried for credit card data, which are encrypted with the public key of the distributor into an Encrypted Credit Card Record (ECCR), a correspondence between said SANId and said ECCR is established and the ECCR with the corresponding SANId is stored in the DB Segment of said registrar, and, when said user pays for goods or services in the Internet or the physical world's retail network, said SANId is entered and used to create and transmit said payment instruction to the registrar's DB Segment, the DB Segment is searched for a transaction account with a matching SANId, the ECCR corresponding to the SANId is retrieved, the ECCR is decrypted using the registrar's private key, and the decrypted data are used to effect the payment.

Preferably, no correspondence between a SANId and an ECCR is established and an ECCR is not stored in a DB Segment, and an ECCR is stored in a payment instruction.

Preferably, said one or multiple addresses from an Address Segment are selected randomly from the plurality of addresses of a transactional system.

Preferably, the transactional instruction stores an encrypted account record.

Preferably, no SANId is stored in the transactional instruction, and the transaction is executed against a decrypted transactional account identifier.

Preferably, an account record is a payment card account record.

Preferably, said account record is encrypted with the Segment's public key.

Preferably, a DB Segment is furnished with a public-private key pair of an asymmetric cryptography scheme, and data are encrypted and decrypted with said key pair.

Preferably, a plurality of SANId's is created, each of which is a DNS identifier, wherein the right-hand part of the identifier or at least the mutable part of the right-hand part is the DNS name of the service provider, and the left-hand part of the identifier is the log-in name of the user or the user's telephone number, and said left-hand part of the identifier is appended to the right-hand side with the “.” (dot) separator.

Preferably, said telephone number is used to contact the user, or for verification or authentication when a transaction is executed.

Preferably, a plurality of SANId's is created, each of which is a DNS name, wherein each SANId is created from an email address, where at least the character “@” (at) is replaced with “.” (dot).

Preferably, a plurality of SANId's is created, each of which is a DNS name, wherein each SANId is created from a telephone number of a user and the DNS name of the telephone communications provider, wherein, at least, the telephone number is appended to the left of the telephone communications provider's DNS name, separating said, at least, telephone number and said DNS name with the “.” (dot) separator.

### PREFERRED EMBODIMENTS OF THE INVENTION

The present invention proposes a method of creation of a payment system by leasing cloud services of an OEM payment system via the Internet, where the hardware and software of the OEM payment system (the payment system cloud) is also on the Internet, using network identifiers as financial account identifiers, as disclosed in the Serebrennikov Application.

Since the Serebrennikov Application pertains to execution of transactions of any nature, describing the preferred embodiments of the present invention as a payment system shall in no way limit the applications of the present invention only to payment transactions, and those skilled in the art will understand that the present invention can be used to build a system for transactions of other nature. Likewise, the use of the Internet in the preferred embodiments shall in no way limit the present invention, which can be advantageously used in other public communications network, such as, for example, a telephone network.

The Serebrennikov Method, put shortly, discloses a method of executing, for example, a payment in the Internet, wherein the identifiers of the payer and payee account in the payment system are real DNS names, for example, payer.pay and payee.pay, registered for the purpose of the example in the hypothetical top-level domain .PAY. Each of the DNS names corresponds to an IP address of the payment system server, handling the account of the payer or the payee, respectively, thus after the resolution of the specified DNS names into IP addresses, as, for example, in the case of

Payer.pay?payer.pay&payee.pay&$100

a network connection with the payer's server in the payment system will be established, whither the payment initiation (an HTTP query) will be sent:

payer.pay&payee.pay&$100

The payer's payment server will retrieve for the query the payer's name payer,pay, and the amount of the payment $100. Then the payment server will verify that the payment system has a payment account with the payer's identifier, and, if the verification is successful, submit the payment into processing. To authenticate the payer, verify data and authorize the payment any known method can be used.

### E-ticket Sales Scenario

The Serebrennikov Application is illustrated by the example of e-ticket sales at a hypothetical site etickets.pay, wherein the buyer has the identifier payer.pay, which corresponds to an IP address of the payment system. The e-ticket buyer visit a page of the site etickets.pay, chooses an e-ticket and select a payment method that uses the method of the Serebrennikov Application. The buyer is requested to agree with the amount and the terms of the payment, and specify the DNS identifier of the payer's account in the payment system. The buyer enters his or her account identifier payer.pay into an appropriate field on the payment page of the site etickets.pay, following which the site etickets.pay creates the string

Payer.pay?payer.pay&etickets.pay&$100

and uses the string to establish an Internet connection using the HTTPS protocol, wherein the name payer.pay will have been resolved via the DNS system into an IP address of the payer's server in the payment system, which etickets.pay will connect to and transmit the payment instruction payer.pay&etickets.pay&$100 to the payer's server in the payment system.

The payer's server in the payment system will verify the existence of the customer account with the identifier payer.pay and if such an account exists, then, for example, to authenticate the payer and authorize the payment, the server etickets.pay will transfer control to the payer's server in the payment system, the payer's server will prompt the payer for a password known to the payer in an appropriate authentication field on a page in the payer's payment system, then the password submitted by the payer will be verified by the payer's server, and, if found correct, the payment will be authorized by the payment system and control will be returned to the site etickets.pay to finish the preparation of the e-ticket. A similar scenario, in particular, is used by the 3DSecure™ technology of the VISA™ company, the only difference being that the buyer enters credit card data rather than the payer's identifier payer.pay, consequently, an existing technology can be used to authenticate payments in the disclosed method, which makes the implementation of the disclosed method inexpensive.

### Account Identifiers for Goods or Services Enterprises (GSE or Merchants)

Each DNS network identifier used to identify a transactional account must be resolvable into an IP address of the cloud. This constrains the delegation policy for DNS names (or URL or URI) used for payments, because it does not allow a free choice of IP addresses for said DNS names, and every IP address must belong to the cloud. On the other hand, this is also a premise for the use of new top-level domain names, where domain names are designated solely for addressing connections for various transactions, including payment addressing. For example, the .book domain can be used to register DNS names of books, which will also serve as account identifiers used to receive payments in the sales of the corresponding book. Similarly, the .app domain can be used to distribute applications, and any other top-level domain to distribute its second-level names as goods paid for by the user (registrant). Therefore, it seems appropriate and preferable to use the .pay domain for payments of any kind.

Persons skilled in the art will know that the first and second stage of second-level domain registration in the new top-level domains are the Sunrise and Landrush periods, during which the owners of registered trade marks register second-level domain names. As a rule, trade marks are owned by Goods or Services Enterprises (GSE), which makes it possible to register DNS names for all GSEs willing to possess transactional accounts in the cloud, such as GSE.TLD, where TLD is any Top-Level Domain in the Internet. Each second-level DNS name GSE.TLD can also be account identifier of a payment system in the payment system cloud. Each GSE may create accounts for goods or services by registering third-level DNS names, such as GOODS.GSE.TLD, wherein the sole constraint is the use of the IP addresses belonging to the payment system cloud.

### Account Identifiers in the Cloud Payment Systems

In accordance with the present invention, a GSE whose second-level DNS account identifier (for example, amazon.pay) was registered during the Sunrise and Landrush period, can be the owner's account identifier, or can become a separate payment system, which can assign third-level DNS names to the goods or services accounts that the GSE sells (for example, kindle.amazon.pay) or can assign third-level DNS names to the accounts of the customers that the GSE serves (for example, Smith.amazon.pay). In the case of identifying goods (services), accounts can preferably be used to receive payments in the sales of the goods (services). In the case of identifying customers, the account can be used for both incoming and outgoing payments.

### Identifiers of Cloud Payment Systems

For the purpose of clearing and settlement, payment systems created in the cloud can also have DNS identifiers for the transactional account of a particular payment system that includes the accounts of customers or goods (services).

As indicated above, the identifiers of cloud payment systems (payment system Segments) can be the second-level DNS names delegated to them, but the payment system Segments can also have other identifiers. At the same time, top-level domains are e-commerce enterprises selling DNS names, which are virtual goods. This makes it possible to make top-level domains the identifiers of the corresponding could payment systems, and the second-level domain name registered in at least one of them (for example, .PAY) the account identifiers of the payment system users.

The payment system cloud may have no DNS identifier for itself, or may have a top-level domain name, for example, .PAY, or may have any other DNS name and a corresponding title.

### Examples of GSE Payment Systems

An example of the payment system having goods (services) accounts can be the payment system of the company Wal-Mart™ or Sportmaster™ or the payment system of the manufacturer Samsung™ or Apple™, where each item of goods can be assigned an URI having the N-level domain name of the item in the hierarchical part of the URI, being the goods account identifier and receiving payments from the buyers of the goods. To search for information on goods, that same URI can be used, except its [?query] part, instead of the payment instruction, will contain a query for data on goods or services.

### Examples of Payment Systems

An example of the payment system having customer accounts can be the payment systems of the free email companies Gmail or Hotmail, or the payment system of the bank Citibank, or the payment system of the online game World of War Craft, or Angry Birds, and so on.

Another example of payment systems can be any top-level domains (for example, .amazon), where the goods or customer accounts are the second-level domains registered in these top-level domains (for example, kindle.amazon).

### Creation of DNS Identifiers for Customer and Goods Account in Payment Systems

At a first stage of the creation of payment system cloud (as disclosed above), the DNS identifiers for payment system transactional accounts are created, but the payment system users may have no DNS names yet to use the disclosed method. The users of online services that use a log-in name and a password to identify their customers may not have DNS names, the customers of telephone communications operators or of free email may not have DNS names, and so on. In such case, the creation of a plurality of DNS identifiers for the customers can be difficult, because:

1. The number of customers can be in millions for certain providers, and creation of DNS identifiers for a large number of existing account can be extremely laborious without using automation.

2. Because the difficulty in remembering the DNS account identifier can be an obstacle to adopting network identifiers for existing customers, it is desirable to use data, already known to the customers, as network identifiers.

3. Because one of the advantages of the use of DNS identifiers to identify accounts is the fact that DNS identifiers, as a rule, are mnemonic (sensible) to be easily remembered by humans and unique at the same time, creation of mnemonic and unique identifiers requires special methods of their creation.

As follows from the considerations above, at least the following requirements can be formulated for network identifiers:

1. Automation. A possibility to automate creation of network identifiers for existing transactional accounts.

2. Knownness. Network identifiers must contain information already known to the holder of the account and to the transactional service.

3. Sensibleness. A network identifier of an account must be mnemonic (sensible) for the holder of the account.

4. Uniqueness. A network identifier must be unique in the entire plurality of transactional accounts handled by a transactional server.

The present invention proposes a procedure for automatic generation of account names for all customers where the CLIENT_ID is either the unique name (log-in) of the account holder used to access the server of the online service provider, or the unique telephone number of the account holder, and so on.

If, for example, the online service provider is Citibank, and the customer's log-in name is the name SAM1CITI, and the customer's telephone number is +1 (212) 1234567 stored in Citibank's database, then, according to the present invention, the following network identifiers for said customer can be created:

12121234567.citibank.com

and/or

sam1citi.citibank.com

Another example is the creation of DNS identifiers for transactional accounts of free email service providers hotmail.com, gmail.com, mail.ru or any other public or corporate mail server. Persons skilled in the art know that all the email addresses at a provider differ only in the log-in name situated to the left of the character @ (at) and the log-in name is a unique user identifier. Replacing the character @ (at) with the character <.>(dot), email addresses are converted to second-level DNS addresses in the service provider's domain, so the email address sam1city@gmail.com will correspond to sam1city.gmail.com.

Telephone communications operators, both mobile and fixed, can create transactional accounts appending their subscriber telephone numbers as a third-level label to the DNS names of the communications provider, for example:

12121234567.att.com

The use of a telephone number in a DNS transactional account identifier is additionally beneficial because it creates an online call-back channel to the use of an account, useful for the purposes of authenticating the user, verifying data, and authorizing payments.

The examples given are equally relevant for creation of DNS account identifiers for goods (services) and customers in top-level domains:

12121234567.att

kindle.amazon

sam1city.google

sam1citi.citibank

angrybirds.apple

ipad-3-16gb.walmart

and so on . . .

As can be seen from the examples, each of the created transactional identifiers is a DNS network identifier and each is compliant with said requirements of automation, knownness, sensibleness, and uniqueness. If these transactional identifiers are put in correspondence with an IP address of the cloud, they can be used to execute transactions in the cloud as disclosed in the Serebrennikov Application and in the present invention.

Even though the examples given above used only the telephone number or the log-in name as a label at a corresponding level to create a real DNS name, such a telephone number or a log-in name can be only a part of the string of said label or be only a mutable part of said label to create a real DNS name at a corresponding level, which is then used as an account identifier for an item of goods, a service, or a user.

### Creation of Payment System Cloud

Assume that a company ABC has created and offers a network service for processing transactions (payments), and that the software doing the processing is hosted at a network server or a group of network servers of company ABC (ABC's server or group of servers are referred to as “the cloud” hereafter), which are accessible by potential customers and the users of the Internet (or other network) at one or more IP addresses (or network addresses of another network), referred to as “the cloud IP index”.

The following illustrates the scenario of using the cloud to create payment systems, for example, for the social network Facebook, for the cellular communications operator AT&T and for the free email server gmail.com, and to execute a payment between the accounts of the cloud payment systems.

Stage 1. Creation of DNS identifiers for customer transactional accounts.

The customers' DNS identifiers can be assigned using any known method for creating and assigning DNS names, wherein the assigned DNS names can be created in any top-level domain and can be DNS names at any level, and the only requirement for them is their uniqueness and correspondence to IP addresses of their respective payment systems.

To create DNS identifiers for transactional accounts of the customers of facebook.com and gmail.com, the email address client_ID@facebook.com and client_ID@gmail.com can be converted to DNS identifiers by repacing the character @ (at) with the character dot, thus the transactional account identifiers will be, correspondingly, client_ID.facebook.com and client_ID.gmail.com.

To create DNS identifiers for transactional accounts of the customers of AT&T, the log-in names used to access AT&T server or the telephone numbers of the customers can be converted to DNS names; for example, the customer with the telephone number +1-212-124567 and the log-in name sam1citi at AT&T can be assigned the identifier 12121234567.att.com or the identifier sam1citi.att.com.

Stage 2. Assigning IP addresses to the payment systems Facebook, Gmail, and AT&T.

Each of the nascent payment systems Facebook, gmail.com and AT&T leases one or more IP addresses from the “cloud IP index”. These one or more IP address are called hereafter the “Facebook IP index”, the “gmail IP index” and the “AT&T IP index” for the corresponding payment system. All of the IP addresses belong to the “cloud IP index” and provide connectivity with the cloud.

Stage 3. Delimitation of payment system processing.

The segments of the cloud, addressed by the “Facebook IP index”, the “gmail IP index” and the “AT&T IP index” are physically or logically separated for the purpose of separating the processing of the payment systems facebook, gmail and AT&T respectively. The delimitation of the “cloud IP index” into indices and processing regions belonging to different payment systems enables separation of accounting and application of different accounting policies regarding the transactions executed by the customers of each payment system, as well as an increased level of security and resilience. In particular, the companies Facebook, Google, AT&T can independently establish different payment fees, autonomously govern user authentication, payment verification and authorization, limit or expand the powers of their customers, offer additional terms and conditions for account use.

Stage 4. Assigning IP addresses to DNS identifiers of transactional accounts.

To make a DNS account identifier of a payment system user an active DNS name in the Internet, it must correspond to an IP address. Hence, each DNS identifier of Facebook's user accounts is put in correspondence with an IP address from the “Facebook IP index”, each DNS identifier of gmail's user accounts is put in correspondence with an IP address from the “gmail IP index” and each DNS identifier of AT&T's user accounts is put in correspondence with an IP address from the “AT&T IP index”. Because of this, the network identifiers of Facebook's user accounts will be resolved to IP addresses from the “Facebook IP index”, the network identifiers of gmail's user accounts will be resolved to IP addresses from the “gmail IP index” and the network identifiers of AT&T's user accounts will be resolved to IP addresses from the “AT&T IP index”, which thus makes it possible to establish connections with the payment system segment of Facebook, or Gmail, or AT&T, correspondingly.

Stage 5. Executing transactions between customer accounts in the created payment systems.

Execution of the payment of $100 from the account 12121234567.att.com to the account clant_ID.gmail.com, for example, can make use, for example, of a string with the connection address and the payment instruction situated after the connection address and the character “?”:

12121234567.att.com?12121234567.att.com&client_ID.gmail.com&$100

In the example given, 1) the connection address (DNS name) 1212124567.att.com is resolved into an IP address from the “AT&T IP index”; 2) an Internet connection (for example, HTTPS) wih AT&T's payment system in the cloud is established; 3) AT&T's payment system is given the payment instruction 12121234567.att.com&client_ID.gmail.com&$100.

After step 3), the payment system must process the payment instruction (an HTTPS query) and respond to the caller resources (an HTTPS response), thus establishing an exchange between the caller resources and the payment system server and execute the payment using, for example, e-ticket sales scenario described above. The caller resource in the example can be any person, including the parties to the payment and the servers of their respective payment systems, and the Internet connection established between the caller resource and AT&T's payment system can be used to organize a process for exchange between the caller resource and the payment system server for the purpose of authenticating the payer/payee, verifying data and authorizing the payment via known methods.

### Distribution of DNS Identifiers for Cloud Financial Accounts Registered in a Particular Top-Level Domain

The Serebrennikov Application discloses a method of encrypting the data of the credit card of a user (customer DNS identifier) with an asymmetric encryption scheme using the public key of transactional service provider, and using DNS identifiers as transactional identifiers, including identifiers of financial accounts.

Assume the .PAY top-level domain is used to create DNS identifiers designated for use as transactional (financial) account identifiers.

The present invention proposes a method for distributing by any third parties of DNS identifiers (for the purpose of the example, the second-level domains registered in the .PY top-level domain will be used hereafter), which are use as financial account identifiers. Assume an Internet user visits the web site of second-level domain distributor at RSLD.PAY. Said distributor offers the user registering a domain in the .PAY top-level domain and use the latter as a financial account identifier to pay for purchases on the Internet and in physical retail networks. The distributors has a System Segment to execute transactions, and all the DNS names distributed in the .PAY domain are used as financial account identifiers for the corresponding users of an arbitrary top-level domain in its transaction execution System Segment, which allows said distributor to receive commission fees from executing transactions by its users who use as the financial account identifiers the DNS identifiers registered by them in the .PAY top-level domain, registered via said distributor.

To identify the distributor's financial account in the transactional system, the distributor may be delegated a particular second-level DNS identifier in the .PAY domain, which is used as the distributor's financial account identifier in the transactional system, and this account can receive the commission from the operations executed by the distributor's users.

The present method can be used to incentivize other top-level domains for distributing domain names in a particular top-level domain (for example, .PAY), since this allows the top-level domains to create a proprietary payment system (transactional System Segment) and receive commission from the payments executed by the users of top-level domains in the Internet and in the physical world's retail networks.

To motivate a user to register a DNS identifier in the .PAY domain, such registration can be offered to user on certain preferential terms, such as offering benefits from registering a DNS name in the .PAY domain, or registering a DNS name in the .PAY domain at a reduced price or free of charge. Another benefit of using a DNS name as a financial account identifier is the intuitive lucidness of the DNS name and that such names are mnemonic, which makes it possible to put them on a business card and memorize them quickly.

### Data Protection, Addressing and Connection Security

The security problems in the use of the present invention can be solved via various methods known to those skilled in the art, as well as the methods disclosed in the present invention.

### Cryptographic Protection of a Cloud Account Data

The Serebrennikov Application discloses a method of creation and use of the Encrypted Account Record (EAR). According to the Serebrennikov Application, an EAR is created via encrypting the account data with a public key of the transactional server, thus only the transactional server can decrypt such a record. The Serebrennikov Application also discloses a method of using the EAR, wherein the EAR is stored and use with the transactional server network address (SNA), whose public key was used to encrypt the EAR. This makes it possible to retrieve the EAR and SNA data, address the transactional server via the SNA and transmit the EAR to the transactional server, which decrypts the EAR using its private key in a asymmetric encryption scheme and uses the decrypted data of Account Record (AR) to execute transactions against the account.

For a credit card account, the method in the Serebrennikov Application makes it possible to encrypt plastic card data with a public key of a server in a card payment processing center and to store the received credit card's EAR in memory with the SNA of a card payment processing center. When executing a payment, the EAR and the SNA of the center are retrieved from memory, a network connection is established with the processing center and the EAR is sent to it, where the EAR is decrypted with the private key of the processing center and then the decrypted card data are used to execute the payment.

The present invention extends the method of the Serebrennikov Application to cloud payment systems. For that, the card data are encrypted with the public key of one of the cloud payment systems and are stored with the IP address from the “IP index” of that payment system, or are stored with the SANId. The data can be stored in memory accessible to the card holder and thus be in possession of the card holder and unknown to the payment system, and be presented to the payment system only at the time of payment. Thus, the EAR can be created by any third party having appropriate cryptographic means, because the public key of the payment system is available to the public as part of the payment system's digital certificate. This helps avoid storing customer data in a single database, which helps avoid the risks of unauthorized access to the EAR data of all the customers simultaneously when criminals gain access to the database and, at the same time, does not create an obstacle or an additional barrier for execution of transactions. When the EARs of various customers of various cloud payments systems are stored, decrypting a particular EAR requires knowledge of what particular payment system's public key was used to encrypt the EAR, which is also difficult to achieve if random sequences of IP addresses are used to form the “IP index” of the particular payment system as is described below in “Use of random sequences”.

When the EAR is not stored in the memory or a database of a transactional system, the EAR can be stored in the transactional instruction by the caller resource and transmitted to the cloud after a connection is established between the caller resource and the cloud.

### Authentication, Verification and Authorization

When seller invoice their customers, the sellers, similarly to merchants (GSEs) in credit card schemes, can be previously attested or approved for participating in a payment system and they can use specially certified or attested means, for example, fixed IP addresses from which they can establish connections with the payment system cloud, as well as secure protocols (for example, HTTPS), special hardware, specific methods, and so on.

### Online Access to Payment Services

Account holders can use the Internet banking technologies for online access to a payment system to execute operations. Because the present invention equally pertains to network names in any network.

### Stability of the Addressing System

In the case of the Internet, a particular concern of organizations such as ICANN is the avoidance of the risks of losing stability and integrity of the DNS system. An important feature of the present invention is that the process of resolving DNS account identifiers into the IP addresses of server with subsequent establishing a connection is separated from the process of executing transactions in the same way as today the process of resolving the DNS name of, for example, Citibank is separated from Citibank's services to execute online payments, which use Citibank's online banking services. Hence the use of the present invention does not involve additional risks for the Internet's DNS addressing system.

Because the invention is applicable to DNS names at any level and registered in any domain of the top or lower level, the invention is not a threat to the stability of the DNS system as a whole, and it is safe for the root of any particular top-level domain.

### Use of Random Sequences

The creation of the “Facebook IP Index”, of the “gmail IP Index” and of the “AT&T IP Index” can be organized as a random process, wherein the plurality of the IP addresses in each index is a random sequence of addresses. This can be achieved by a random selection of an IP address from a sequential IP index for inclusion into the IP index of a particular payment system. Such a method of assigning IP addresses will not allow the attachment of a particular IP address to a particular payment system to be determined. The random sequence of IP addresses in an index will also not allow a particular payment system's number of customer to be determined using public DNS services. When cryptographic keys of a payment system are used, the random plurality of IP addresses in an IP index of the payment system will not let malefactors determine the cryptographic keys of which system are used in a connection with a particular IP address in the payment system cloud.

As is seen from the description of the invention and as is demonstrated on examples, the disclosed method makes it possible to create new systems for transaction execution, and, in particular, payment systems, rapidly and promote the nascent payment systems under the names of their respective lessees/users, to automate creation of DNS account names, to protect transactional account data for their secure storage and transmission in a communications network. Creation of transactional systems, generation of account network identifiers, protection and distribution of the identifiers and transactional account data can via the use of the present invention be organized in realtime, while creation of payment systems, generation of account network identifiers, protection, secure storage and exchange of transactional account data can be short in duration and be accessible in the cost of acquisition and ownership to both small businesses and large corporations.

Persons skilled in the art will find it obvious that the present invention admits various modifications and changes. Consequently, the present invention shall include said modifications and changes and their equivalents without digressing from the essence and the body of the invention disclosed in the claims section.

1. A method of creating a payment system in a communications network, comprising establishment in the communications network of a connection between the caller and the callee resources using a network connection addressing system of said communications network; said network connection addressing system having a database that stores network identifiers and network addresses, each network identifier in said database corresponding to at least one network address; said network addressing system making available to caller resources a resolver service, comprising receiving a network identifier of a callee resource from a caller resource, searching in the addressing system's database for a network address corresponding to the network identifier of the callee resource, and returning the found network identifier of the callee resource to the caller resource, the caller resource using the obtained network identifier of the callee resource to establish a network connection with the callee resource of the network; a transactional system having a transactional account database and being a network resource, each transactional account in the transactional system's database being assigned a transactional Account Network Identifier (ANId); the transactional system being assigned one or multiple Transactional System Network Addresses (TSNA), and said TSNA's are used to establish connections between network caller resources and the transactional system, which is a network resource; said ANIds corresponding in the network addressing system's database to at least one TSNA; creation of a transactional instruction to execute a transaction, said instruction having at least one ANId, use of the network connection addressing system's resolver service, said ANId being transmitted to said network connection addressing system and the resolver service executed for said ANId, and at least one TSNA, corresponding in the network connection addressing system's database to said ANId, returned, said TSNA used to establish a network connection with the transactional account database, which is given said transactional instruction with at least one said ANId; further comprising subdivision of the transactional system into at least two Segments, each Segment being given an individual Segment in the transactional account database (DB Segment), subdivision of the plurality of TSNA's into disjoint address subsets (Address Segments) corresponding to Segments, said Address Segments being used to address connections exclusively with their respective DB Segments; creation in a selected DB Segment of at least one transactional account, for which at least one Segment Account Network Identifier (SANId) is created, and said SANId corresponds in the network connection addressing system's database to at least one address in the corresponding Address Segment; said SANId being used to create said transactional instruction, to establish a connection with said DB Segment and to send said instruction to said DB Segment.

2. The method of claim 1, further comprising retrieval of a SANId from a received transactional instruction and application of a known rule to execute a transaction against the account whose identifier is identical with the SANId retrieved from said transactional instruction.

3. The method of claim 1, wherein said transactional system is a payment system, transactional accounts are financial accounts, and the transactional instruction is a payment instruction having at least the SANId of the payer and the amount of payment, and the the SANId identifier in the payment instruction identifies the financial account of the payer in the corresponding DB Segment.

4. The method of claim 1, wherein said network identifiers and DNS names or Uniform Resources Identifiers (URI), and the network addresses are IP addresses.

5. The method of claim 4, further comprising allocation of a payment system Segment to an N-level DNS name registrar, said N-level DNS names registered by the registrar being used as said SANIds to identify financial accounts in said DB Segment, each SANId corresponding to at least one network address in a corresponding Address Segment, and the SANId and at least one said address in the Address Segment corresponding to said SANId are stored in the network connection addressing system's database.

6. The method of claim 5, further comprising creation of said payment system in a selected top-level Internet domain, wherein second-level DNS identifiers registered in said top-level Internet domain are used as said SANIds, said registrar is another top-level Internet domain, and said payment system Segment is used as a payment system of a distributor.

7. The method of claim 6, wherein said selected Internet top-level domain is the .PAY domain.

8. The method of claim 5, wherein said registrar is furnished with private and public keys of an asymmetric cryptography scheme, and said users, when registering said SANId's, are queried for credit card data, which are encrypted with the public key of the distributor into an Encrypted Credit Card Record (ECCR), a correspondence between said SANId and said ECCR is established and the ECCR with the corresponding SANId is stored in the DB Segment of said registrar, and, when said user pays for goods or services in the Internet or the physical world's retail network, said SANId is entered and used to create and transmit said payment instruction to the registrar's DB Segment, the DB Segment is searched for a transactional account with a matching SANId, the ECCR corresponding to the SANId is retrieved, the ECCR is decrypted using the registrar's private key, and the decrypted data are used to effect the payment.

9. The method of claim 6, wherein no correspondence between a SANId and an ECCR is established, an ECCR is not stored in a DB Segment, and an ECCR is stored in a payment instruction.

10. The method of claim 1, wherein said one or multiple addresses from an Address Segment are selected randomly from the plurality of addresses of a transactional system.

11. The method of claim 1, wherein the transactional instruction stores an encrypted account record.

12. The method of claim 11, wherein no SANId is stored in the transactional instruction, and the transaction is executed against a decrypted identifier of a transactional account.

13. The method of claim 11, wherein the account record is a payment card account record.

14. The method of claim 11, wherein said account record is encrypted with the Segment's public key.

15. The method of claim 1, wherein a DB Segment is furnished with a public-private key pair of an asymmetric cryptography scheme, and data are encrypted and decrypted with said key pair.

16. The method of claim 1, wherein a plurality of SANId's is created, each of which is a DNS identifier, the right-hand part of the identifier or at least the mutable part of the right-hand part being the DNS name of the service provider's server, and the left-hand part of the identifier being the log-in name of the user, used to access the service provider's server, or the user's telephone number, and said left-hand part of the identifier is appended to the right-hand side with the “.” (dot) separator.

17. The method of claim 16, wherein said telephone number is used to contact the customer, or for verification or authentication when a transaction is executed.

18. The method of claim 1, wherein a plurality of SANId's is created, each of which is a DNS name, each SANId being created from an email address, replacing at least the character “@” (at) with “.” (dot).

19. The method of claim 1, wherein a plurality of SANId's is created, each of which is a DNS name, each SANId being created from a telephone number of a user and the DNS name of the telephone communications provider, appending, at least, the telephone number to the left of the telephone communications provider's DNS name, separating said, at least, telephone number and said DNS name with the “.” (dot) separator.
